(19) United States
(12) Patent Application Publication
(10) Pub. No.: US 2025/0305589 A1
(43) Pub. Date: Oct. 2, 2025

(54) LOW WATER HAMMER BREAK CHECK VALVE

(71) Applicant: Mueller International, LLC, Atlanta, GA (US)

(72) Inventors: Sean Michael Allen, Chattanooga, TN (US); Sean Gant, Chattanooga, TN (US); Kenneth Blake Hammonds, Ohatchee, AL (US); Aleksandr I. Migovich, Chattanooga, TN (US); David Latimore Hughes, JR., Signal Mountain, TN (US); Paul S. Gifford, Chattanooga, TN (US); Christopher Joseph Duckett, Guntersville, AL (US)

(21) Appl. No.: 18/616,301

(22) Filed: Mar. 26, 2024

(51) Int. Cl. F16K 15/02

(52) U.S. Cl. CPC F16K 15/023

(57) ABSTRACT

A valve closure device for a break check valve is provided. The device includes one or more valve members configured to rotate from an open position to a closed position only when a pipe system fitting initially coupled to the break check valve is separated from the break check valve, and a dampener coupled to the valve member in the open position and the closed position of the valve member. The one or more valve members can be configured to discontinue fluid communication through the break check valve during a separation event. The dampener can include a hydraulic dampener or a biasing element configured to slow movement of the one or more valve members towards the closed position thereof.

### TECHNICAL FIELD

### Field of Use

This disclosure relates to break check valves in a fluid distribution system. More specifically, this disclosure relates to break check valves comprising a dampener or biasing member to slow closure.

### Related Art

Property damage and water loss can occur when a pipe system fitting or, more specifically, a pipe system termination fitting such as a hydrant—in particular a wet barrel fire hydrant—that terminates a specific branch of a fluid distribution system is hit by a moving vehicle or otherwise broken free from its usual position in the system. Sudden stoppage of flow in such a system—at the aforementioned pipe fitting or elsewhere—can itself also result in damage to the system. While an in-line break check valve configured for use with a hydrant could mitigate such property damage and water loss, such valves can result in water hammer if they close too quickly. Such a valve can be considered a break check valve in that it “checks” movement of the fluid when the pipe system fitting is broken away from the valve but not in the sense that it necessarily prevents backward flow of liquid. Moreover, overly rapid closure of such valves can cause not only water hammer but also a pressure spike resulting in an excessive load on the components of the system sufficient in some cases to cause a failure of one or more of those components.

### SUMMARY

It is to be understood that this summary is not an extensive overview of the disclosure. This summary is exemplary and not restrictive and is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a valve closure device for a break check valve, the device comprising: a valve member configured to rotate from an open position to a closed position only when a pipe system fitting initially coupled to the break check valve is separated from the break check valve; and a hydraulic dampener coupled to the valve member in each of the open position and the closed position of the valve member, the hydraulic dampener configured to resist rotation of the valve member towards the closed position of the valve member.

In a further aspect, disclosed is a valve closure device for a break check valve, the device comprising: a valve member configured to rotate from an open position to a closed position only when a pipe system fitting initially coupled to the break check valve is separated from the break check valve; a cylinder; and a biasing element received within or coupled to the cylinder, the biasing element configured to resist rotation of the first valve member towards the closed position of the valve member.

In yet another aspect, disclosed is a break check valve comprising: a valve body defining a mating surface at a first axial end, the valve body defining a valve bore, the valve bore extending from a first axial end to a second axial end; a valve member positioned within the valve body and configured to rotate from an open position to a closed position; and a dampener coupled to each of the valve body and the valve member, the dampener configured to resist rotation of the valve member during closure of the break check valve, the dampener defining: a first end configured to be coupled to a valve body of the break check valve; and a second end distal from the first end with respect to an axis of the valve closure device and configured to be coupled to the valve body only through the first end; and the dampener comprising one of a hydraulic dampener and a biasing element.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, explain various principles of the disclosure. The drawings are not necessarily drawn to scale. Corresponding features and components throughout the figures may be designated by matching reference characters for the sake of consistency and clarity.

FIG. 1 is a side elevation view of a system comprising a pipe fitting, a break check valve secured to the pipe fitting, and a hydrant secured to the break check valve with a traffic flange in accordance with one aspect of the current disclosure.

FIG. 2 is a side elevation view of the system of FIG. 1 after dislocation of the hydrant from the break check valve, the accompanying shearing of the traffic flange, and subsequent closure of the break check valve.

FIG. 3 is a perspective view of the break check valve and the traffic flange of FIG. 1, the break check valve comprising a valve closure device and shown in an open position.

FIG. 4A is a sectional view of the break check valve and the traffic flange of FIG. 3 taken along line 4-4 of FIG. 3 and with the break check valve shown in the open position.

FIG. 4B is a detail sectional view of the break check valve of FIG. 3 taken from detail 4B of FIG. 4A.

FIG. 4C is a detail sectional view of the break check valve of FIG. 3 taken from detail 4C of FIG. 4A.

FIG. 5 is a sectional view of the break check valve and the traffic flange of FIG. 3 also taken along line 4-4 of FIG. 3 and with the break check valve shown in a closed position.

FIG. 6 is a sectional view of a break check valve in accordance with another aspect of the current disclosure, also taken along line 4-4 of FIG. 3 and shown in an open position.

FIG. 7 is a sectional view of the break check valve of FIG. 6 also taken along line 4-4 of FIG. 3 and shown in a closed position.

FIG. 8 is a perspective view of the break check valve of FIG. 3 in accordance with another aspect of the current disclosure and shown in the open position.

FIG. 9 is a sectional perspective view of the break check valve of FIG. 8 taken along line 9-9 of FIG. 8 shown in an open position.

FIG. 10 is a sectional view of the break check valve of FIG. 8 also taken along line 9-9 of FIG. 8 and shown in an open position.

FIG. 11 is a sectional view of the break check valve of FIG. 8 also taken along line 9-9 of FIG. 8 and shown approaching a closed position.

FIG. 12 is a perspective view of a valve closure device of the break check valve of FIG. 8 in accordance with another aspect of the current disclosure, the valve closure device shown in a partially open position.

FIG. 13 is a side view of the valve closure device of FIG. 12 in the partially open position.

FIG. 14 is a sectional view of the valve closure device of FIG. 13 taken along line 14-14 of FIG. 12 and shown in the partially open position.

FIG. 15 is a perspective view of the break check valve of FIG. 3 in accordance with another aspect of the current disclosure and shown in an open position.

FIG. 16 is a sectional view of a break check valve of in accordance with an aspect of the current disclosure, taken along line 16-16 of FIG. 15 and shown in the open position.

FIG. 17 is a perspective view of a break check valve in accordance with another aspect of the current disclosure and shown in an open position.

FIG. 18 is a perspective view of the break check valve of FIG. 17 taken along line 18-18 of FIG. 17 and shown in the open position.

FIG. 19 is a sectional view of a break check valve in accordance with another aspect of the current disclosure and shown in the open position.

FIG. 20 is a sectional view of a break check valve in accordance with another aspect of the current disclosure and shown in the open position.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams. Unless otherwise specified herein, any structure disclosed in the drawings or in the written description as being so formed can be monolithic whether or not such an explicit description of the structure is included herein.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of a break check valve nearest to an outlet of the valve, and “rear” is the end of the break check valve which can be opposite or distal the front. “Horizontal” or “horizontal orientation” describes that which is in a plane extending from left to right and aligned with the horizon. “Vertical” or “vertical orientation” describes that which is in a plane which can be angled at 90 degrees to the horizontal.

In one aspect, a break check valve and associated methods, systems, devices, and various apparatuses are disclosed herein. In one aspect, the break check valve or a valve closure device thereof can comprise a hydraulic dampener. In one aspect, the break check valve or a valve closure device thereof can comprise a biasing element. In some aspects, the break check valve can be as disclosed in U.S. Pat. No. 11,725,746, issued Aug. 15, 2023, which is hereby incorporated by reference herein in its entirety.

Break check valves such as those typically used with wet barrel hydrants can suffer from excessive water hammer upon activation, which can adversely affect aging infrastructure. Efforts have been made to reduce water hammer and its effects, but the effects remain. Because closing even a dry barrel hydrant too quickly can also cause water hammer, one solution in the industry is to simply close the hydrant very slowly. The break check valve disclosed herein imitates slow closure and thereby can reduce or eliminate the water hammer.

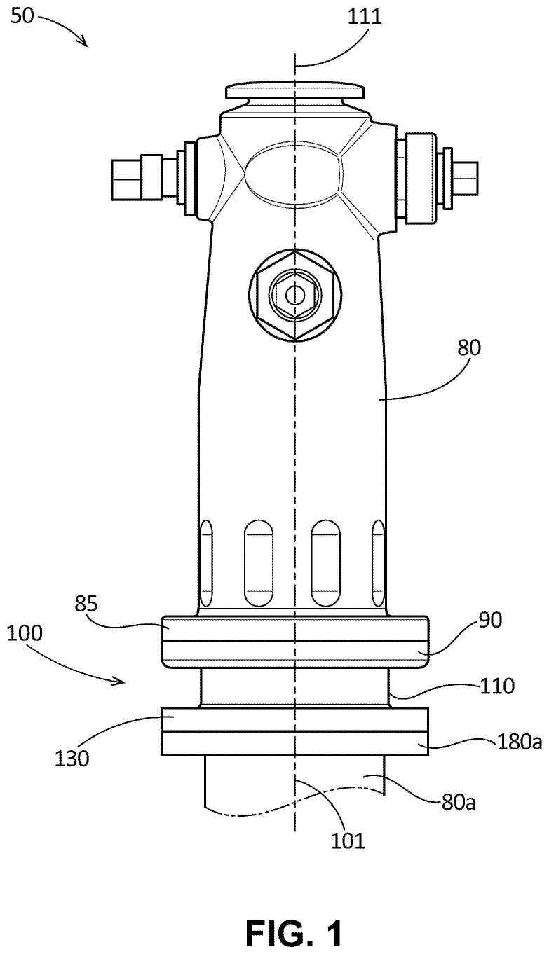

FIG. 1 is a side elevation view of a system showing a pipe system fitting or fitting 80, which as shown can be, for example, a wet barrel hydrant, assembled to a break check valve 100. The fitting 80 can define an axis 111, which can be aligned with an axis 101 of the break check valve 100 and can extend through the fitting 80. The fitting 80 can comprise a mounting flange 85 which can be disposed proximal to an end of the fitting 80. The mounting flange 85 can be configured to be received by a traffic flange 90. The traffic flange 90 can comprise two halves and can connect the fitting 80 to the break check valve 100. The traffic flange 90, which can be configured to sacrificially fail upon contact with the fitting 80 by another object, e.g., a moving vehicle, can comprise semicircular half-rings. The break check valve 100 can comprise a break check valve body or valve body 110. The valve body 110 can comprise a lower flange 130, which can be in communication with a receiving flange 180a of a pipeline 80a and provide fluid communication therewith. In some aspects, the lower flange 130 can comprise a plurality of through holes 131 disposed about the perimeter thereof. In some aspects, the through holes 131 can be sizably configured to receive a fastener, such as a pipe bolt (not shown), which can be configured to releasably secure the lower flange 130 and/or the valve body 110 to the pipeline 80a. In an exemplary aspect, the break check valve 100 can be connected to the pipeline 80a by way of bolting the lower flange 130 to the receiving flange 180a of the pipeline 80a via threaded fasteners received by the through holes 131. The pipeline 80a can be operable to provide a pressurized source of fluid to the fitting 80. In some aspects, the fitting 80, the break check valve 100, and the pipeline 80a can be coaxial about the axes 101,111.

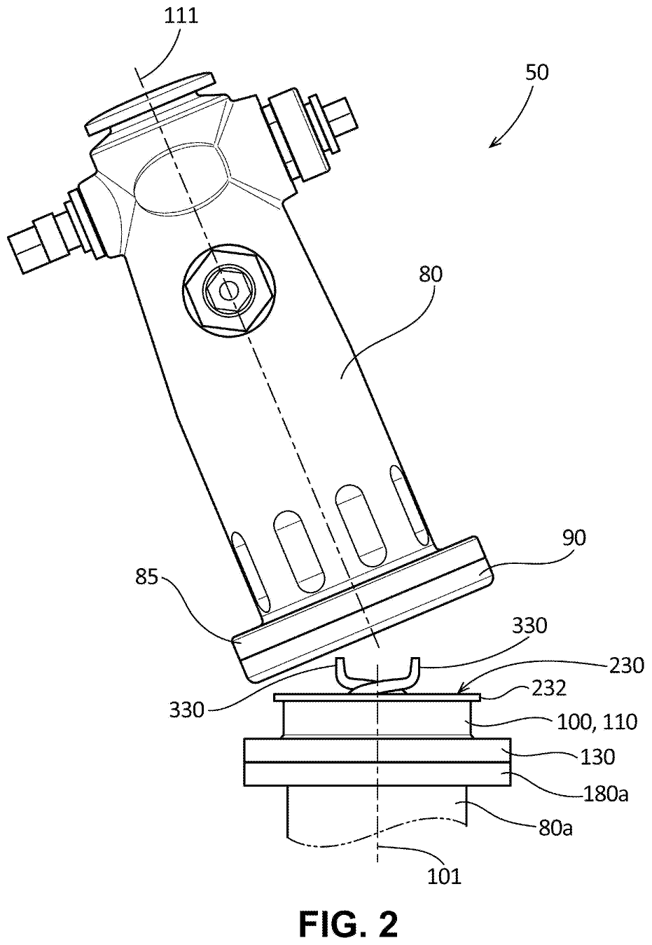

FIG. 2 is a side elevation view of the system of FIG. 1 after dislocation of the fitting 80 from the break check valve 100 and subsequent closure of the break check valve 100. Such a dislocation of the fitting 80 can result, for example, during an impact with a vehicle or the like. During dislocation, the break check valve 100 can become activated and the valve member arms 330 can now be visible above or beyond a mating surface 230 of the break check valve 100. In some aspects, as shown, the fitting 80 can be structurally configured to separate at the mating surface 230. In particular, the traffic flange 90 can fail and can become disengaged from the top flange 232 during a dislocation event. Further, the fitting 80 can be configured so that the lower flange 130 is substantially resistant to dislocation during a dislocation event.

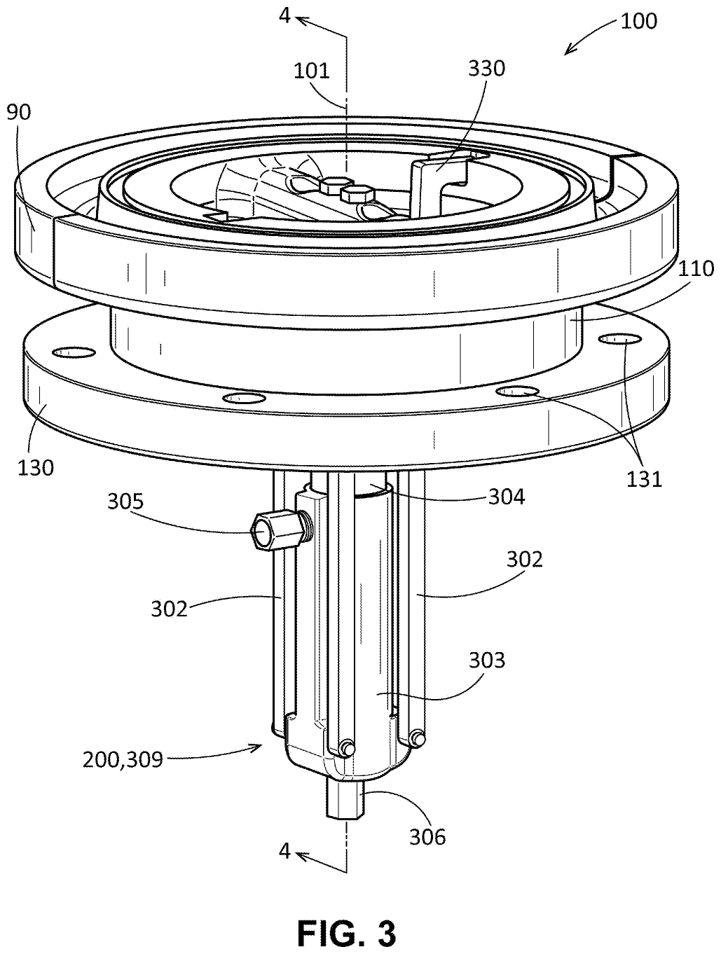

FIG. 3 is a top perspective view of the break check valve 100 of FIG. 1, shown in an open position. The break check valve 100 can comprise a valve body 110 and a traffic flange 90 which can be configured to be in mechanical communication with a fitting 80 such as, for example, and without limitation, a hydrant. The break check valve 100 and one or more portions thereof can define the axis 101 of the break check valve 100. The break check valve 100 can comprise a valve closure device 200. The break check valve 100 and, more specifically, the valve closure device 200 can comprise a hydraulic dampener 309 which can be placed in mechanical communication with the valve body 110. In some aspects, the hydraulic dampener 309 can comprise a piston 304 and a cylinder or first cylinder 303. The hydraulic dampener 309 can comprise a combination of at least the piston 304 and the cylinder 303. The piston 304 can be received by or within the cylinder 303 and structured to slidably translate therein. In some aspects, the hydraulic dampener 309 can be in fluid communication with the fluid source, such as the pipeline 80a. In some aspects, the hydraulic dampener 309 can be configured to provide a force to the valve body 110. 100. In some aspects, the break check valve 100 can comprise a cylinder 303 in fluid communication with a fluid source, such as the pipeline 80a, and in mechanical communication with the piston 304. The valve body 110 can comprise at least one linkage 302 which can be in mechanical communication with the cylinder 303. The linkage 302 can be defined by an elongated member having a first end mechanically coupled to the cylinder 303 and a second end mechanically coupled to the valve member 301. The linkage 302 can be configured to, when urged by the cylinder 303, relocate the valve member 301. In some aspects, the linkage 302 can comprise a fastener at an end such as a pin or screw at the first and/or second end. In some aspects, the linkage 302 can be configured to be substantially rigid and remain undeformed. In some aspects, the valve body 110 can comprise one or more pairs of symmetrically spaced linkages 302.

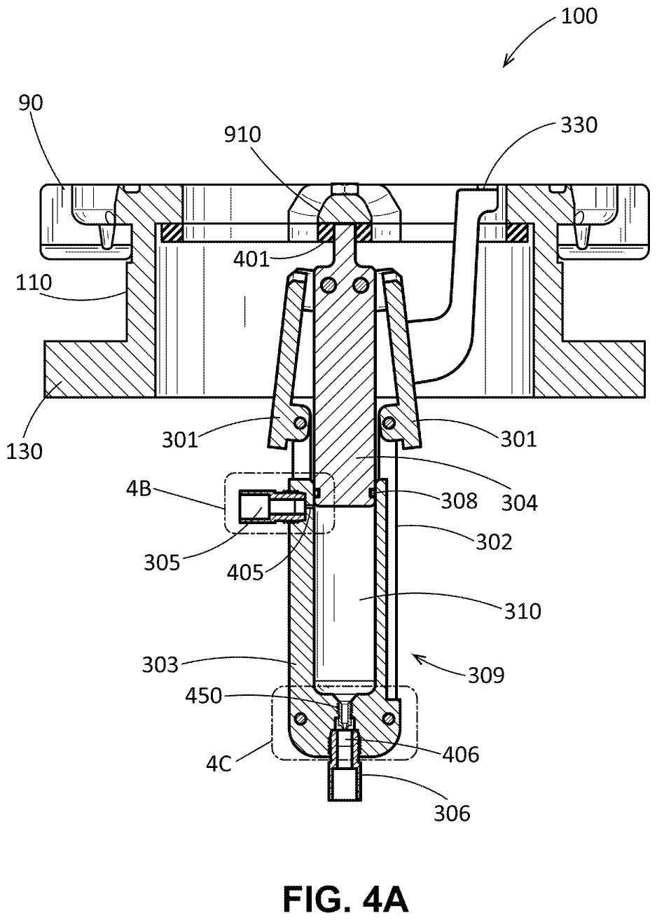

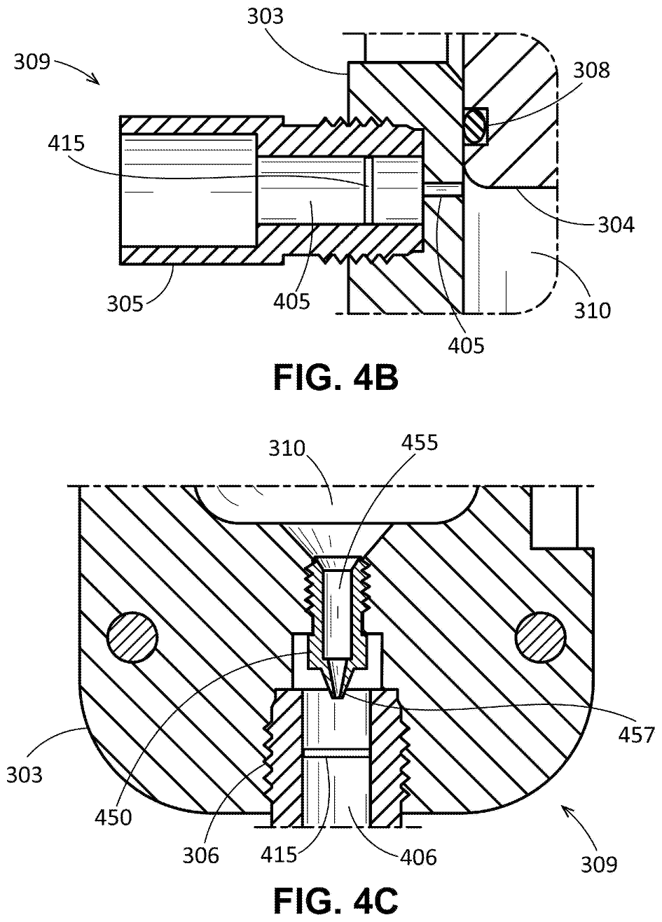

The hydraulic dampener 309 can comprise a first fitting or inlet fitting or air bleed fitting 305, which can be in fluid communication with the cylinder 303 and, more specifically, an inner cavity or cylinder cavity 310 thereof. The cylinder 303 can comprise a second fitting or exit fitting 306, which can be disposed on or received in the cylinder 303. In some aspects, the exit fitting 306 can be a check valve defined as a passage having an inlet thereto and an outlet therefrom. More specifically, the exit fitting 306 can be configured to provide one-way directional fluid flow. Each of or either of the air bleed fitting 305 and the exit fitting 306 can contain a screen or strainer or filter 415 (shown in FIG. 4), which can be operable to prevent debris such as particulates from passing therethrough. In some aspects, the filter 415 or the fittings 305,306 need not be present. In some aspects, the break check valve 100 can comprise at least one valve member arm 330, which can extend from a corresponding valve member 301 or otherwise be coupled to a surrounding portion of the break check valve 100.

FIG. 4A is a sectional view of the break check valve 100 of FIG. 3 shown in the open position. In some aspects, when the break check valve 100 is in an open position, a fluid, such as a fluid stored in the fitting 80 can pass through the valve body 110. In some aspects, the valve body 110 can be filled with fluid from, for example, a fluid source. The break check valve 100 can remain in an open position when the fitting 80 (shown in FIG. 1) is located along the axis 101. When the break check valve 100 is in an open position, the cylinder cavity 310 can be filled with a fluid from, for example and without limitation, a water source.

The break check valve 100 can comprise the valve closure device 200. More specifically, as shown, the valve closure device 200 can be coupled to the check valve body 110 and, more specifically, a cross member 910 thereof, the valve closure device 200 can comprise one or more valve members 301. As shown, the valve closure device 200 can comprise a pair of valve members 301. The valve members 301 can be sizably configured to sealably engage an inner surface of the check valve body 110. The valve members 301 can be, for example, a pair of semicircular valves or valve plates that together form a substantially circular disc. The valve members 301 can be pivotably coupled to the piston 304 and can define an open and closed position. In some aspects, the linkages 302 can be adapted to couple the cylinder 303 to the valve members 301. The valve member 301 can be coupled to the valve member arm 330. The cylinder 303 can be a substantially hollow extruded body having an interior area which can define therein the cylinder cavity or cylinder cavity 310. In an exemplary aspects, the air bleed fitting 305 and/or the exit fitting 306 can be fluidly coupled with the cylinder cavity 310. More specifically, the air bleed fitting 305 and the exit fitting 306 can define an air bleed port 405 and an exit port 406, respectively.

In some aspects, the cylinder 303 can comprise a hollow cross section. In some aspects, the cylinder 303 can have, for example and without limitation, a cylindrical, elliptical, rectangular, prismatic, or rectilinear cross section. In some aspects, the piston 304 can comprise a substantially similar cross section to the cylinder 303. The piston 304 can be configured to be received by or within the cylinder 303 at an opening of the cylinder cavity 310 and can slidably translate therethrough. In the current aspects, the cylinder 303 can be substantially circular and can define a circular cylinder cavity 310 through which the piston 304 can travel. The cylinder 303 can be operable to control the movement of the valve members 301 and linkages 302.

FIG. 4B is a detail sectional view of the break check valve 100 of FIG. 3 taken from detail 4B of FIG. 4A, and FIG. 4C is a detail sectional view of the break check valve 100 of FIG. 3 taken from detail 4C of FIG. 4A. As shown in FIG. 4B, at least a portion of the air bleed port 406 can be defined by the air bleed fitting 305 and at least a portion of the air bleed port 406 can be defined by the cylinder 303. Again, each of or either of the air bleed fitting 305 and the exit fitting 306 and, more generally, the cylinder 303 can comprise the filter 415, which can be configured to filter and can filter contaminants from a fluid surrounding an outside of the cylinder 303 and, more generally, the hydraulic dampener 309 of the valve closure device 200 (shown in FIG. 3). In some aspects, any such contaminants can otherwise clog or block either or both of the air bleed port 405 and the exit port 406. In some aspects, for example and without limitation, either or both of the air bleed fitting 305 and the exit fitting 306 can be or comprise a high-pressure inline filter or filter part no. 9811K7 available from McMaster-Carr. In some aspects, either or both of the air bleed fitting 305 and the exit fitting 306 and, more specifically, the filter 415 can remove particles as small as 25 microns. In some aspects, either or both of the air bleed fitting 305 and the exit fitting 306 can be porous or comprise a porous material, which can comprise stainless steel.

As shown in FIG. 4C, the exit fitting 306 or an adjacent portion of the hydraulic dampener 309 surrounding the exit fitting 306 and/or defining the exit port 406 can comprise or be defined by a nozzle 450. The nozzle 450 can be coupled to the cylinder 303 and, more specifically, can be coupled to or define a portion of the exit port 406. As shown, the nozzle 450 can be threadably received within a portion of the exit port 406 defined by the cylinder 303. The nozzle 450 can define a first end and a second end. The second end can comprise or define a nozzle tip 457, an inner diameter of which can be smaller than an inner diameter of a bore 455 defined by either the first end of the nozzle 450 or a remaining portion of the nozzle 450. The smaller inner diameter of the nozzle tip 457 can facilitate metering of the fluid from the cylinder cavity 310 during operation or activation of the break check valve 100. More specifically, the smaller inner diameter of the nozzle tip 457 can restrict or slow movement of the cylinder cavity 310 during such operation or activation. In some aspects, for example and without limitation, the nozzle 450 can be or comprise a three-dimensional printer nozzle part no. 3695N316 available from McMaster-Carr. In some aspects, the opening diameter of the nozzle 450 can be 0.25 millimeters (0.0098 inches) or less.

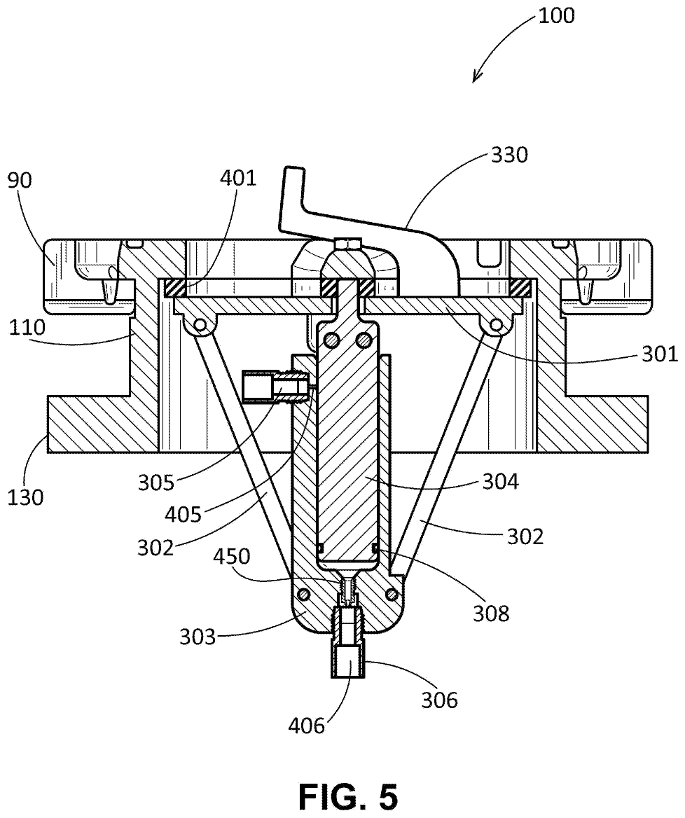

FIG. 5 is a sectional view of the break check valve 100 of FIG. 3 and shown in a closed position. The break check valve 100 can be configured to move from an open position to a closed position during a dislocation event, such as a hydrant impact resulting in a closure event. In some aspects, the break check valve 100 can comprise the air bleed fitting 305, which can again define the air bleed port 405. The air bleed port 405 can be defined, at least in part, in the air bleed fitting 305 and, at least in part, in the cylinder 303. In some aspects, the air bleed fitting 305 can be separate from the cylinder 303. In some aspects, the air bleed fitting 305 can comprise a portion extending from the cylinder 303 and a portion received within the cylinder 303. The air bleed fitting 305 can be coupled to the cylinder 303 and can be further be operable to provide fluid communication with the cylinder 303 and the cylinder cavity 310 thereof. In some aspects, the air bleed port 405 can define a variable diameter cavity. The air bleed fitting 305 can be threadedly connected to the cylinder 303 and can be coupled in fluid communication therewith. In some aspects, the air bleed port 405 can be configured to allow for purging of air or any trapped gas from the cylinder 303. The piston 304 can comprise a seal or gasket or O-ring 308 or other sealing apparatus which can be operable to form a substantially fluid tight seal between the piston 304 and the cylinder 303. The seal 308 can be operable to discontinue fluid communication between the cylinder 303 and the air bleed port 405. More specifically, the air bleed port 405 can be configured to allow passage of fluid to or from the cylinder cavity 310 as long as the piston 304 or at least the seal 308 has not passed in an axial direction past and thereby blocked the air bleed port 405 but upon such movement can discontinue or interrupt such fluid communication. During a closure event, water pressure from the water source can urge the valve members 301 to move from an open position to a closed position and can sealably engage with the valve body 110. The linkages 302 can be configured to move with the valve members 301 and urge the cylinder 303 upwardly and in engagement with the piston 304.

In some aspects, the break check valve 100 can comprise the exit fitting 306. The exit fitting 306 can define a cavity in a section of the cylinder 303. In some aspects, the exit fitting 306 can be separate from the cylinder 303. In some aspects, the exit fitting 306 can comprise a portion extending from the cylinder 303 and a portion received within the cylinder 303. The exit fitting 306 can be structured with a hollow cavity coupled to the cylinder 303 and operable to provide fluid communication therewith. In some aspects, the exit fitting 306 can define a variable diameter cavity. The exit fitting 306 can be configured to allow water to escape from the cylinder cavity 310. The piston 304 can be operable to force water from the cylinder cavity 310 through the exit fitting 306. The movement of the cylinder 303 relative to the piston 304 can be resisted by the exiting water through the exit fitting 306 and can delay the closure of the valve members 301. In some aspects, the magnitude of the resistance can be determined by an inner diameter of the exit fitting 306.

The break check valve 100 can comprise a seal 401, which can be positioned between the check valve body 110 and the valve members 301 in the closed positions of the valve members 301. The seal 401, which can be a shim or spacer, and can be positioned along or aligned with the axis 101 of the break check valve 100 below a flange of the valve body 110. The seal 401 can define a first or upper surface and a second or lower surface opposite from the upper surface. The seal 401 can define an outer diameter, an inner diameter, and a thickness in an axial direction with respect to the axis 101. The inner diameter of the seal 401 can be substantially equal to at least an inner diameter of the check valve body 110 proximate to or at the traffic flange 90, and the outer diameter of the seal 401 can be less than or equal to an inner diameter of the check valve body 110 adjacent to the traffic flange 90. The seal 401 can be formed from an elastomeric material such as, for example and without limitation, rubber (e.g., a natural rubber or a synthetic rubber such as VITON™ rubber), neoprene, or ethylene propylene diene.

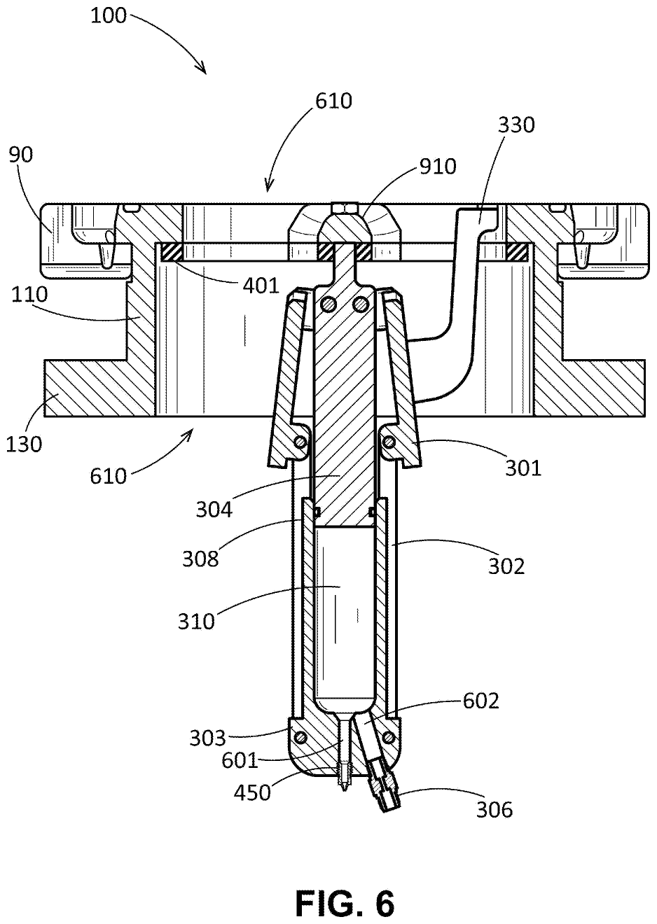

FIG. 6 is a sectional view of the break check valve 100 of FIG. 3 in accordance with another aspect of the current disclosure and shown in an open position. In some aspects, the exit fitting or fitting 306 can be disposed on the surface of the cylinder 303 or received within the cylinder 303 and can be in fluid communication with the cylinder cavity 310. The cylinder 303 can define a passage 601. The passage 601 can be in fluid communication with the cylinder cavity 310 and can be configured to provide hydraulic access from the water source to the cylinder cavity 310. The passage 601 can be operable to provide additional hydraulic flow to the cylinder 303. In some aspects, the passage 601 can work together with the exit fitting 306. The passage 601 can meter or restrict passage of fluid from inside the cylinder cavity 310 during closure of the break check valve 100 and thereby slow closure of the break check valve 100. More specifically, positioning of the nozzle 450 in the passage 601 or otherwise in fluid communication with the fluid exiting the cylinder cavity 310 can meter or restrict passage of fluid from inside the cylinder cavity 310 during closure of the break check valve 100 and thereby slow closure of the break check valve 100. In some aspects, the passage 601 can provide hydraulic access to the fluid source, such as the pipeline 80a. In some aspects, the valve body 110 can be substantially hollow and can define therein an inner cavity 610 having an inlet thereto and an outlet therefrom. The inner cavity 610 can be configured to provide fluid communication between the water source and the fitting 80.

The fitting 306 can be or can comprise a check valve, which can allow fluid flow in only one direction, e.g., into the passage 602 and the cylinder cavity 310. In some aspects, the fitting 306 can be received a passage 602 defined in the cylinder 303. In some aspects, upon closure of the break check valve 100 and the accompanying movement of the cylinder 303 with respect to the piston 304 in an axial direction, the fitting 306 can, as a check valve, prevent flow through the passage 602. Flow of the fluid inside the cylinder cavity 310 can instead be restricted to flow through the passage 601. By such restriction and metering of the fluid from the cylinder cavity 310, closure of the break check valve 100 can be slowed and water hammer reduced or eliminated.

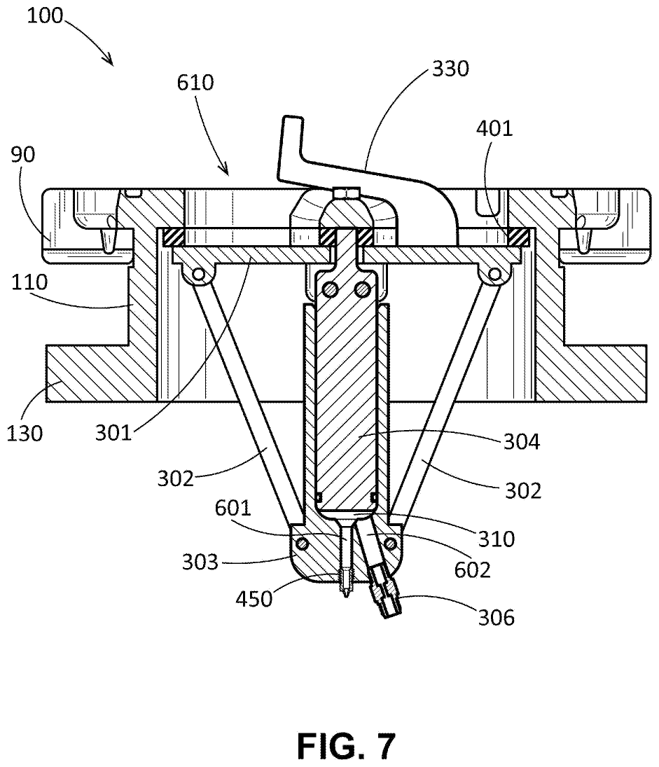

FIG. 7 is a sectional view of the break check valve 100 of FIG. 3 shown in a closed position. In some aspects, a volume of the cylinder cavity 310 can be substantially reduced in a closed position relative to an open position. Further, when in a closed position, the valve members 301 can form a substantially circular shape and can be engaged—even forcibly—with the seal 401 via the linkages 302 along the interior of the valve body 110. The combination of the seal 401 and the valve members 301 can discontinue fluid communication in the closed position. In some aspects, the piston 304 can be operable to force water from the cylinder cavity 310 through the passage 601 and the nozzle 450 and can create a resistance force which can resist the cylinder 303 from translating upwardly relative to the piston 304. In some aspects, the nozzle 450 can be left out and the passage 601 can, by itself, define a smaller opening such as defined in the nozzle 450. In some aspects, the nozzle 450 can be left out and the passage 601 can define a larger opening (e.g., much larger than the opening defined in the nozzle 450) as shown and thereby allow greater flow to and from the cylinder cavity 310 through the passage 601. In some aspects, the resistance force can be transferred to the valve members 301 via the linkages 302 and retard the articulation of the valve members 301.

Upon resetting of the break check valve 100, the check valve of the fitting 306 can allow flow of the fluid back into the cylinder cavity 310—even in a speed that can be significantly greater than, e.g., two or more times or even 5 or 10 times, the flow that would be allowed through the passage 601, especially with the nozzle 450. More specifically, physical movement of valve members 301 during a resetting of the break check valve 100 (e.g., by manipulation by a user of the valve members 301 towards the open position in the process of preparing the break check valve 100 to receive and securably mate with a new pipe system fitting 80) can create a vacuum inside the cylinder cavity 310, which will tend to draw fluid into and re-fill the cylinder cavity 310. The break check valve 100 can thereby be reset more quickly by use of the check valve of the fitting 306, and the fitting 306 can thereby be configured to facilitate quicker reset of the break check valve 100. More specifically, quicker flow of the fluid (e.g., 5 or 10 times the fluid that would be allowed back into the cylinder cavity 310 without the fitting 306 as a check valve) can facilitate a reset of the break check valve 100 in one-fifth or one-tenth of the time. In some aspects, for example and without limitation, the break check valve 100 can be reset in 30 seconds or less. At the same time, in some aspects, it can be beneficial to limit the speed at which the cylinder cavity 310 is re-filled with fluid by sizing the fitting 306 to not allow too much flow and/or by instructing a user to take a least a certain amount of time to reset the valve. In some aspects, for example and without limitation, a user can be instructed to take at least 10 seconds to reset the break check valve 100. Thus in some aspects, for example and without limitation, the break check valve 100 can be configured to be reset in greater than or equal to 10 seconds and less than or equal to 20 seconds, 30 seconds or one minute.

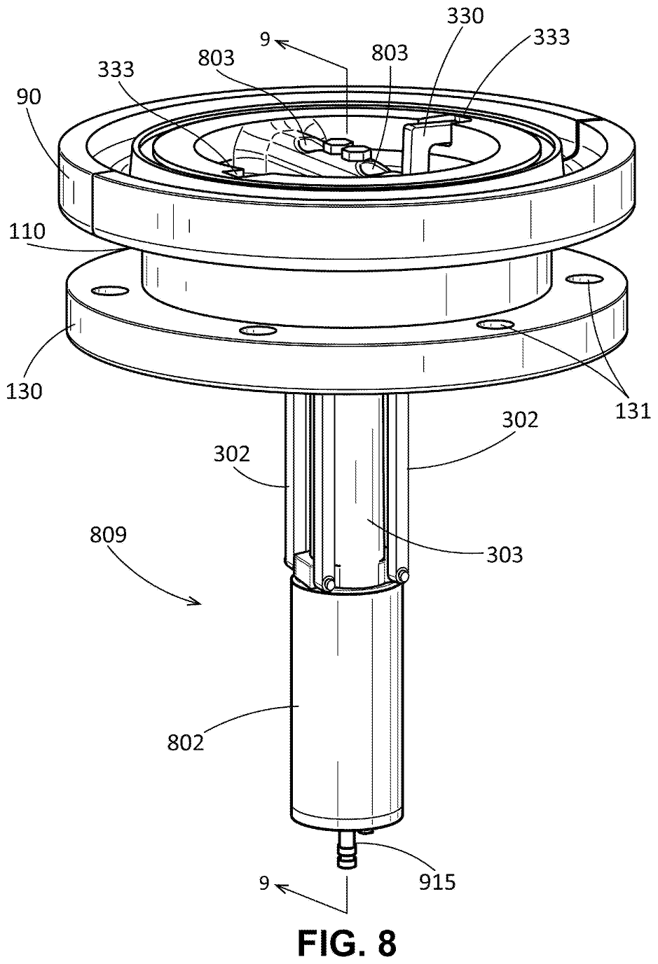

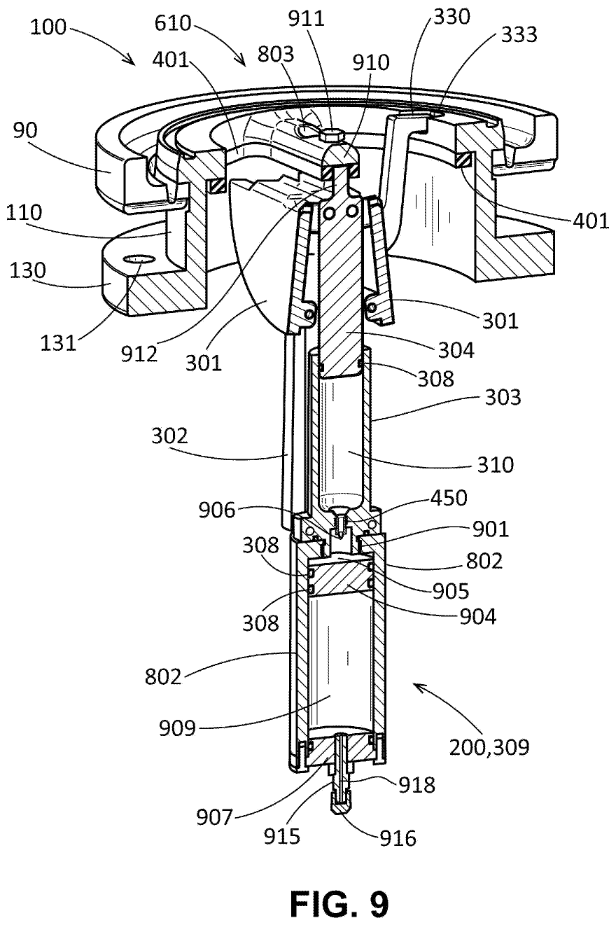

FIG. 8 is a perspective view of the break check valve 100 in accordance with another aspect of the current disclosure and shown in an open position prior to a closure event. The break check valve 100 can comprise at least one valve member arm 330 disposed or received within the valve body 110. The valve member arm 330 can be in mechanical communication with the valve member 301. In an open position, the valve member arms 330 can be received by a recess 333 defining a perimeter proximal to the valve body 110 and structures to receive the valve member arm 330. The break check valve 100 and, more specifically, the valve closure device 200 can comprise the cylinder 303, which can be a main cylinder; a plurality of linkages 302, which can be in mechanical communication with the valve member 301 (shown in FIG. 5); and an accumulator cylinder or second cylinder 802. The linkages 302 can be configured to translate with the second cylinder 802 and simultaneously articulate the valve members 301. The second cylinder 802 can be adapted to be coupled to the cylinder 303. An assembly of at least the second cylinder 802 and an accumulator piston 904 (shown in FIG. 9) can form a dampener 809. In some aspects, the accumulator piston 904 can be the piston 304 of other embodiments. In some aspects, the second cylinder 802 can be threadedly received by the cylinder 303. In some aspects, the break check valve 100 can comprise a gas fill fitting 915, which can be disposed on or received within the second cylinder 802.

FIG. 9 is a cross sectional view of the break check valve 100 of FIG. 8 taken and shown in the open position prior to a closure event. The break check valve 100 and, more specifically, the valve members 301 are shown in the open position. In some aspects, the break check valve 100 can comprise a position block 912 which can be secured to the cross member 910 of the valve body 110 via a cross member fastener or fastener 911. In some aspects, the cross member fastener 911 can be adapted to facilitate securably locating the piston 304 to the cross member 910. The piston 304 and, more specifically, a mounting end thereof can be secured to the position block 912. The piston 304 and, more specifically, the working end thereof can be slidably secured to either or both of the cylinder 303. Again, one or more of the seals 308 can seal a joint between the piston 304 and the cylinder 303 and thereby prevent passage of fluid therebetween. In some aspects, the valve cross member 910 can comprise one or more signal holes 803. The signal holes 803 can be in fluid communication with the break check valve 100. The signal holes 803 can be sizably configured to provide a stream of fluid during a dislocation event. For example only, during a dislocation event, the signal holes 803 can be structured to receive a fluid from the fluid source, such as a pipeline 80a and emit said fluid upwardly relative to the break check valve 100 in a substantially continuous stream. After a dislocation of the fitting 80, such a continuous stream can provide a visual indicator to an individual that a dislocation event has occurred.

In some aspects, the break check valve 100 can comprise a second cylinder 802, which can be threadedly received by the cylinder 303 via a threaded joint 901. An accumulator nozzle 906, which can be the nozzle 450, can be positioned therebetween and provide fluid communication between the cylinder 303 and an accumulator cylinder volume or accumulator cylinder cavity 905. A diameter of the accumulator nozzle 906 can be sizably configured to control the rate of fluid transfer. In some aspects, the rate of fluid transfer can be proportional to the closure speed of the valve members 301. The second cylinder 802 can comprise the accumulator cylinder cavity 905, the accumulator piston 904, a cylinder plug 907, and a gas chamber or gas cavity 909. In some aspects, the gas cavity 909 can be filled with nitrogen, although other compressible fluids or, more specifically, gases, are contemplated. In some aspects, the cylinder plug 907 can be disposed at an end of the second cylinder 802. In some aspects, the cylinder plug 907 can be retained at an end of the second cylinder 802 via one of, for example and without limitation, a threaded fastener, an interference fit, or a welded joint. In some aspects, the cylinder plug 907 can comprise the gas fill fitting 915, which can define a gas fill port 918 therein. The gas fill fitting 915 can comprise a valve, which can be configured to provide fluid access between the gas cavity 909 and a gas source. In some aspects, the gas fill fitting 915 can be configured to provide one way fluid access. In some aspects, the gas fill fitting 915 can comprise a bleed off means to release fluid contained in the gas cavity 909. As shown, the gas fill fitting 915 can comprise a cap 916, which can selectably open and close access to the gas fill port 918 and can be secured (e.g., threadably) to a remaining portion of the gas fill fitting 915. The second cylinder 802 can be configured to receive a working fluid from the cylinder 303 via the accumulator nozzle 906 which can act on the accumulator piston 904. In some aspects, the working fluid can urge the accumulator piston 904 to translate and alter a volume of the accumulator cylinder cavity 905 and the gas cavity 909. In some aspects, the motion of the accumulator piston 904 can be resisted by the gas in the gas cavity 909. The second cylinder 802 can be connected to the linkages 302 and dampen the motion of the valve members 301 during a closing event.

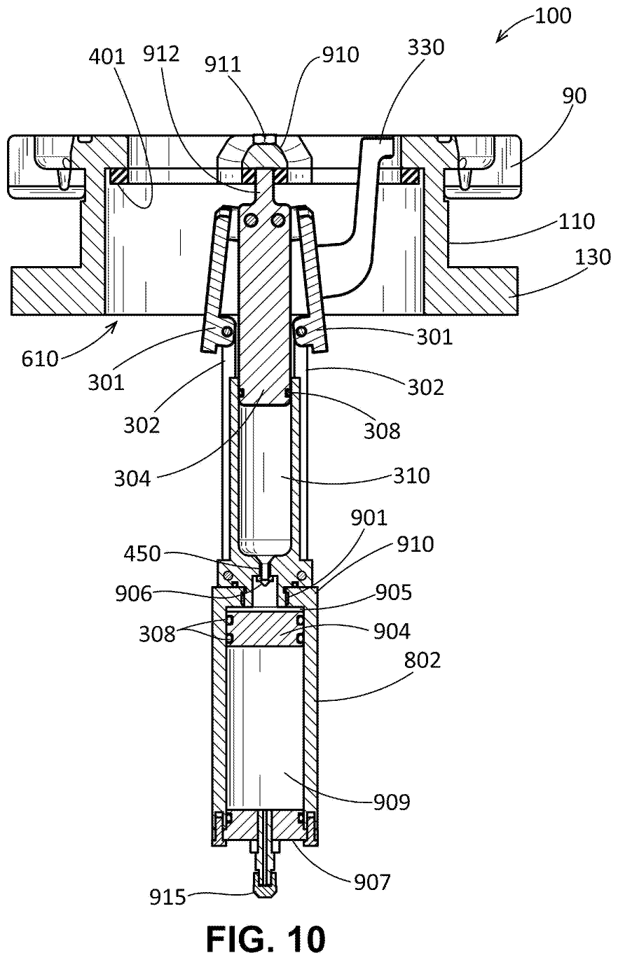

FIG. 10 is a sectional view of the break check valve of FIG. 8 is shown in an open position. As shown, the valve member arms 330 can be formed separately from and fastened to the valve members 301. In some aspects, the valve member arms 330 can be fastened to the valve members 301 by welding or with weldments at a joint or seam between the valve member arms 330 and the valve members 301. In some aspects, the valve member arms 330 can be fastened to the valve members 301 using another type of fastener such as, for example, and without limitation, a screw or a pin or can slide or snap into position inside the valve member 301 without the use of any fasteners. In particular, in some aspects, the valve members 301 can define respective recesses which can be sized to receive respective bases of the valve member arms 330. The valve member arms 330 can be substantially “S” shaped and can be mounted in an orientation or in a plate which can be orthogonal to a pivot axis formed from the valve members 301.

In some aspects, the break check valve 100 can comprise an second cylinder 802 which can be threaded onto the cylinder 303 and in fluid communication therewith via the accumulator nozzle 906. The accumulator nozzle 906 can be configured to provide a passage for a working fluid to move between the cylinder 303 and the second cylinder 802. In some aspects, the cylinder 303 can be slidably received by the piston 304, wherein the piston, when in motion, can be configured to urge the working fluid between the cylinder 303 and second cylinder 802. In some aspects, the piston 304 can be configured to urge the working fluid from the cylinder 303 to the second cylinder 802 through the accumulator nozzle 906. In some aspects, the working fluid can urge the accumulator piston 904 to compress the gas within the gas cavity 909. In some aspects, the gas in the gas cavity 909, can resist the motion the accumulator piston 904 and retard the motion of the second cylinder 802 and cylinder 303. In some aspects, the linkages 302 can be connected to the cylinder 303 and move in accordance with the cylinder 303. In some aspects, the linkages 302 can be in mechanical communication with the valve members 301.

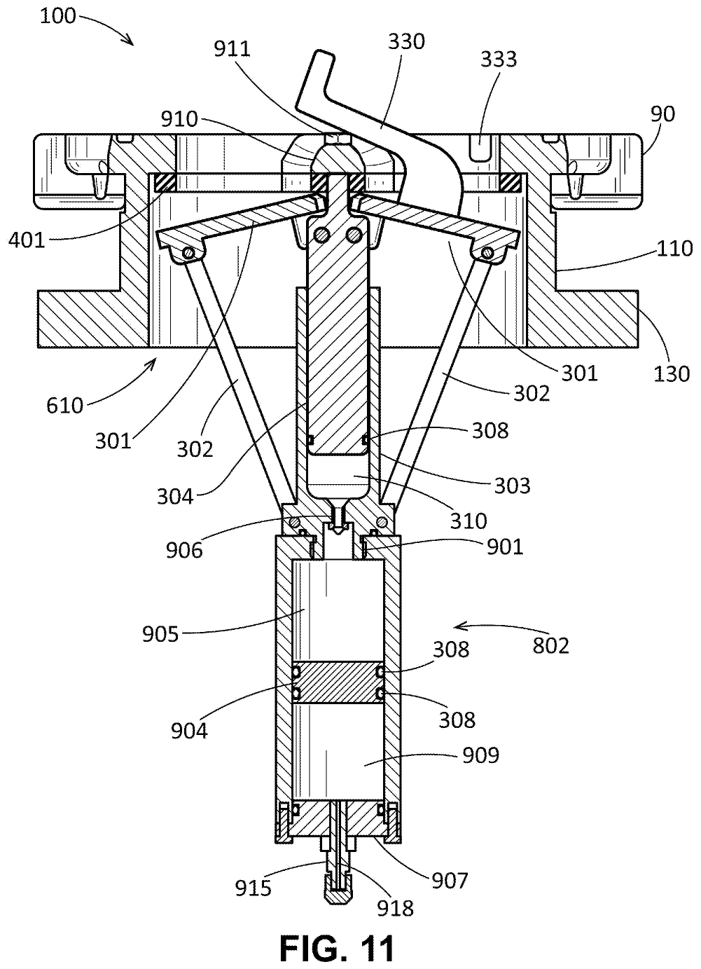

FIG. 11 is a sectional view of the break check valve of FIG. 8 and shown approaching a closed position after dislocation of the fitting 80 and during closure of the break check valve 100. During closure of the valve members 301 and the seal 401 can limit flow of the fluid (e.g., water) of the system only through one or more of the signal holes 803, which can be included in the valve body 110. The signal holes 803 can vary in quantity, size, and location. As the piston 304 moves in an axial direction with respect to the cylinder 303, the sum of the remaining volume of the cylinder 303 can be decreased. In some aspects, the motion of the piston 304 can be configured to urge a working fluid into the second cylinder 802 via an accumulator nozzle 906. The speed and resistance of the working fluid can be controlled via the configuration of the diameter of the accumulator nozzle 906. By increasing or decreasing the aforementioned diameter, the speed and acceleration of closing of the valve members 301 can correspondingly be increased or decreased. More generally, different valve closure speeds and accelerations can result from adjusting the sizes, quantities, and axis of the accumulator nozzle 906. In some aspects, the resistance provided to the valve members 301 can be adjustable. In some aspects, the cylinder 303 and/or the second cylinder 802 can be configured to contain therein and transfer therebetween a fluid having a viscosity. In some aspects, resistance provided to the valve members 301 can be configured based on the viscosity and/or other fluid properties of the fluid.

An effective surface area of the valve members 301 can equal or can substantially equal an effective surface area of the inner cavity 610. The effective surface area can be an actual surface area of the corresponding valve members 301 or a projected surface area as measured along a direction such as, for example, the axis 101 of the break check valve 100. The symmetry of the valve body 110—including, for example, the aforementioned effective surface areas—can cancel out any and all horizontal loads acting on components of the valve body 110 such that the resultant force on surrounding portions of the break check valve are only along the direction of the axis 101. Furthermore, such symmetry can cause an equal or substantially equal closing speed of each of the valve member 301 during closure of same and can thereby cause simultaneous or substantially simultaneous closure of the valve member 301 against mating portions of the break check valve 100 such as, for example and without limitation, the seal 401. “Substantially” equal or simultaneous generally means that a particular value or property is close enough for any differences to be immaterial to the basic performance of the structure.

In several aspects, the second cylinder 802 can be in communication with the cylinder 303. The accumulator nozzle 906 can be disposed therebetween. The second cylinder 802 can comprise the accumulator piston 904 and the cylinder plug 907 and define the gas cavity 909 and the accumulator cylinder cavity 905. In some aspects, the cylinder plug 907 can be configured to contain a fluid within the gas cavity 909. In some aspects, the fluid within the gas cavity 909 can be or can comprise nitrogen. As the working fluid is urged from the cylinder 303 to the second cylinder 802 by the piston 304 to the second cylinder 802 through the accumulator nozzle 906 during a closing event, it urges the accumulator piston 904 to compress the gas within the gas cavity 909. The compression of the gas in the gas cavity 909 can retard the motion of any of the second cylinder 802, cylinder 303, and valve members 301. In some aspects, after the fitting 80 is reattached, the pressure can be released from the water source. In such a scenario, the valve member 301 would not be acted on by any water pressure. The compressed nitrogen in the gas cavity 909 can provide a force which can urges the accumulator piston 904 towards the cylinder 303, which urges the working fluid to return to the cylinder 303 resulting in the reopening of the break check valve 100.

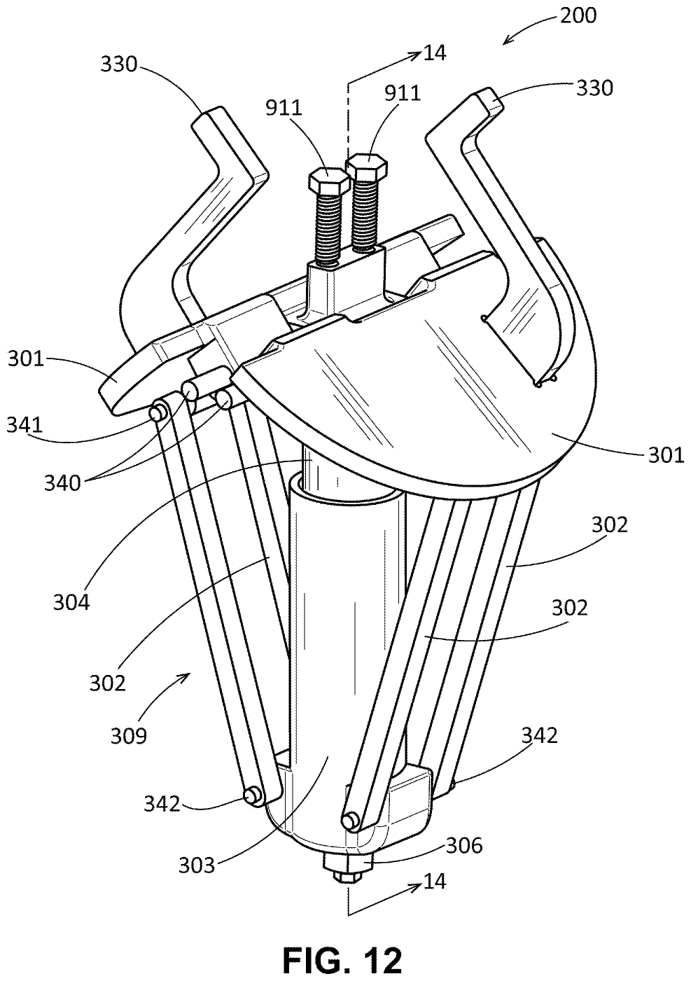

FIG. 12 is a top perspective view of a valve closure device 200 of the break check valve 100 of FIG. 1 in accordance with another aspect of the current disclosure, the valve closure device 200 shown in a partially open position. In some aspects, the valve closure device 200 can be disposed within the valve body (not shown). In some aspects, the valve closure device 200 can be secured to the valve body (not shown) by coupling the valve closure device 200 to the cross member 910 via the fasteners 911. As shown, a first end of the linkage 302 can be coupled or joined to the valve member 301 via a first linkage pivot 341. When the break check valve 100 can be activated the linkages 302 urge the valve member 301 to rotate about a disc pivot or pivot 340. In some aspects, the pivot 340 can comprise a pin which can extend through the valve members 301 and provide a hinged connection thereto. The pivot 340 can be configured to provide a rotating locus for the valve member 301. The valve member 301 can nest together and can align along or with the first linkage pivot 341. Each of the valve members 301 and can define a substantially semicircular shape when nested and a substantially circular shape when engaged. In some aspects, including the “double” valve member 301 (e.g., the use of two valve members 301) as shown, each of the valve members 301 can define a substantially semicircular shape. In some aspects, a second end of the linkage 302 can be coupled to the cylinder 303 via a second linkage pivot 342. In some aspects, the second linkage pivot 342 can be configured to provide a range of motion through which the linkage 302 can rotate.

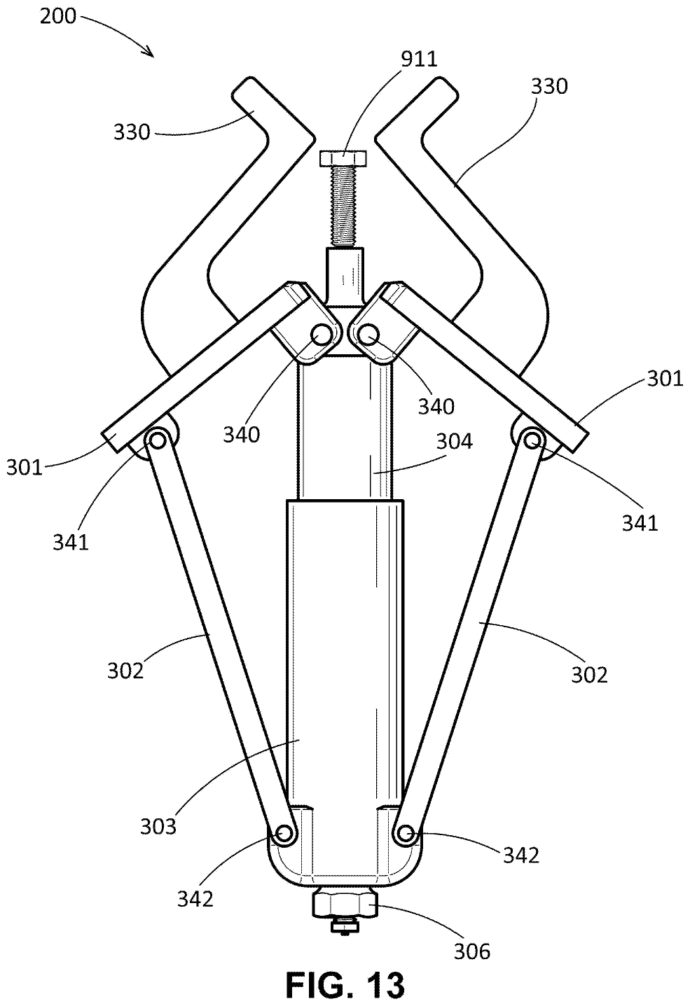

FIG. 13 is a side elevation view of the valve closure device 200 of FIG. 12 in the partially open position. In some aspects, the cylinder 303 can be configured to be slidably received by the piston 304. In some aspects, the first end of the linkage 302 can be pivotably received by a first linkage pivot 341 disposed on the valve member 301 and the second end of the linkage 302 can be pivotably received by a second linkage pivot 342 disposed on the cylinder 303. The linkage 302 can be configured to provide mechanical communication between the cylinder 303 and the valve member 301. As shown, the cylinder 303 can comprise two linkages 302 per valve member 301. In some aspects, only one linkage 302 can be used per valve member 301. In some aspects, as shown in FIG. 13, using the two linkages 302 per valve member 301 can permit the valve member 301 to open further in a fully open position and one or more surfaces of the respective valve member 301 in the fully open position can more closely align with the axis 101. The linkages 302 can be formed from a rigid material. The linkages 302 can be formed into a shape such as, for example and without limitation, a bar or a wire. The linkages 302 can hold and can be configured to hold the cylinder 303 in the desired position with respect to the piston 304 in the open position of the break check valve 100, in the closed position of the break check valve 100, and in each position therebetween.

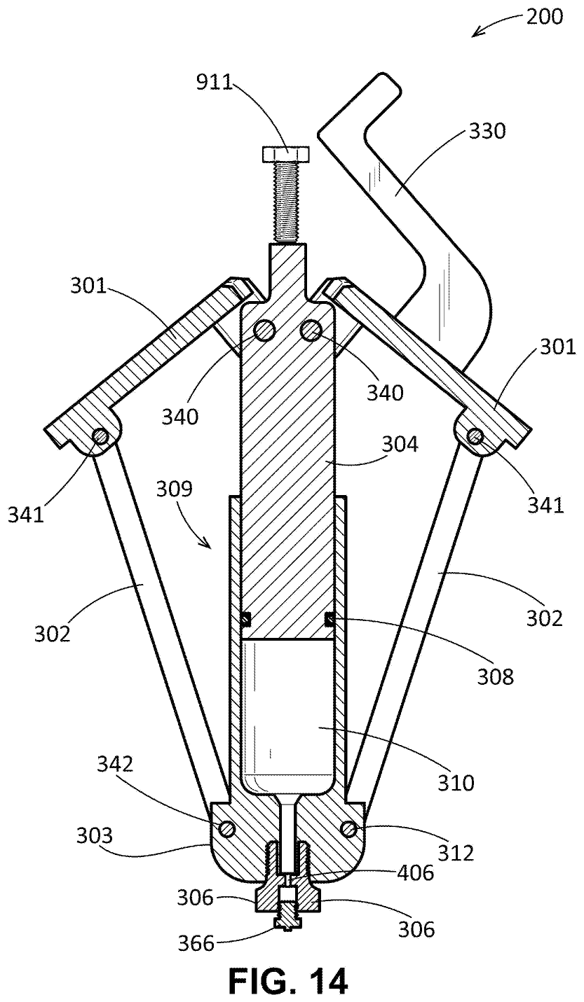

FIG. 14 is a sectional view of the valve closure device 200 of FIG. 12 and shown in the partially open position. In some aspects, the piston 304 and cylinder 303 together can comprise the hydraulic dampener 309 operable to retard the acceleration of the valve member 301 during closure. In some aspects, the hydraulic dampener 309 can define the exit fitting 306 proximate to the second end, which can be in fluid communication with the hydraulic dampener 309 and configured to provide fluid transfer and regulate the rate thereof. In some aspects, the exit fitting 306 can comprise a male and female two-piece construction. In some aspects, the exit fitting 306 can comprise a exit fitting cap 366, which can be received by the exit fitting 306. The exit fitting cap 366 can be detachably secured by the exit fitting 306 and can be operable to discontinue or adjust fluid communication. In some aspects, the exit fitting 306 can comprise or define a nozzle or nozzle portion. In some aspects, the exit fitting cap 366 can be threadedly received by the exit fitting 306. In some aspects, the exit fitting cap 366 can comprise a hole extending therethrough which can provide lower fluid transfer when compared to the exit fitting 306 without the exit fitting cap 366. The exit fitting cap 366 can be structured to adjust the fluid flow from the exit fitting 306 by way of increasing, decreasing, or terminating fluid flow therefrom. For example and without limitation, tightening or loosening of the exit fitting cap 366 can close or open one or more passages in the threading which can be defined in the exit fitting cap 366 and thereby prevent or allow passage of a fluid therethrough. As shown, the hydraulic dampener 309 assembly can hold a dampening fluid such as, for example, and without limitation, an oil in an interior cavity of the hydraulic dampener 309 such as the cylinder cavity 310 of the cylinder 303. The oil can comprise mineral oil in some aspects. The water can be from a fluid source such as a pipeline 80a or the water contained within the break check valve 100. In some aspects, the dampening fluid can be a gas such as air. The dampening fluid can be different than a fluid of the fluid source, but like other aspects of the valve closure device 200 disclosed herein the dampening fluid can be configured to resist rotation of the valve member 301 towards the closed position of the valve closure device 200. In some aspects when the valve closure device 200 is activated during a closing event, the valve member 301 and linkages 302 urge the cylinder 303 to engage with the piston 304, thereby reducing the volume of the cylinder cavity 310. In some aspects, the cylinder cavity 310 contains air which can be pressurized by the piston 304 during a closure event and forced through the exit fitting 306, retarding the motion of the valve member 301 and linkages 302. In some aspects, the hydraulic dampener 309 can be configured to reset after a closure event. For example, the hydraulic dampener 309 can reposition the fluid in the inner chambers such that the hydraulic dampener 309 can function during a subsequent closing event.

During closure of the valve member 301, the seals 308 can ensure that the dampening fluid does not escape the cylinder 303 and instead only passes between the cylinder cavity 310 and the exit fitting 306. In some aspects, the seal 308 can be positioned between the piston 304 and the cylinder 303 to facilitate a seal therebetween and thereby prevent the dampening fluid from leaving the cylinder 303. As the valve members 301 attempt to rotate and the cylinder 303 attempts to slide over the piston 304, each can move only as fast as the piston 304 can evacuate or push the dampening fluid from the cylinder cavity 310 through the exit fitting 306. Again, the exit fitting 306 can define the exit port 406.

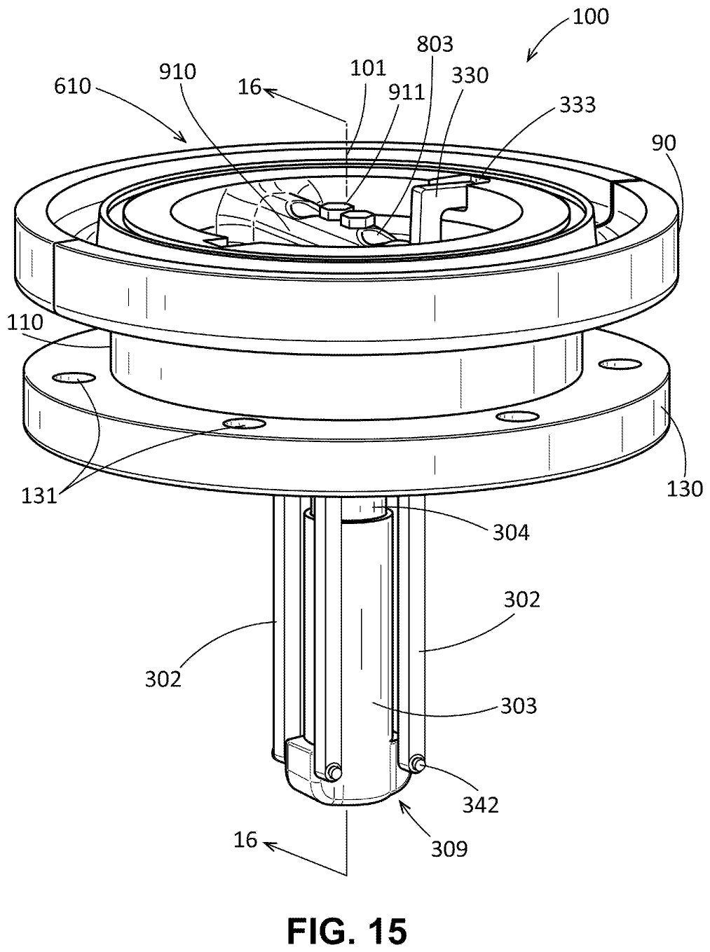

FIG. 15 is a perspective view of the break check valve 100 of FIG. 1 in accordance with another aspect of the current disclosure and shown in an open position. In some aspects, the valve member arms 330 can be received by or within a recess 333 in the inner cavity 610 of the valve body 110 such as in an inner perimeter thereof, as shown. Prior to a dislocation event, the valve member arm 330 can be suppressed by the fitting 80 and held in place. In some aspects, while the break check valve 100 is in the open position, the valve member arms 330 can be configured to restrain any of the piston 304, the cylinder 303, or the valve member 301 in an open position. In some aspects, the valve member arms 330 can be configured to resist the closing force applied by the hydraulic dampener 309 assembly.

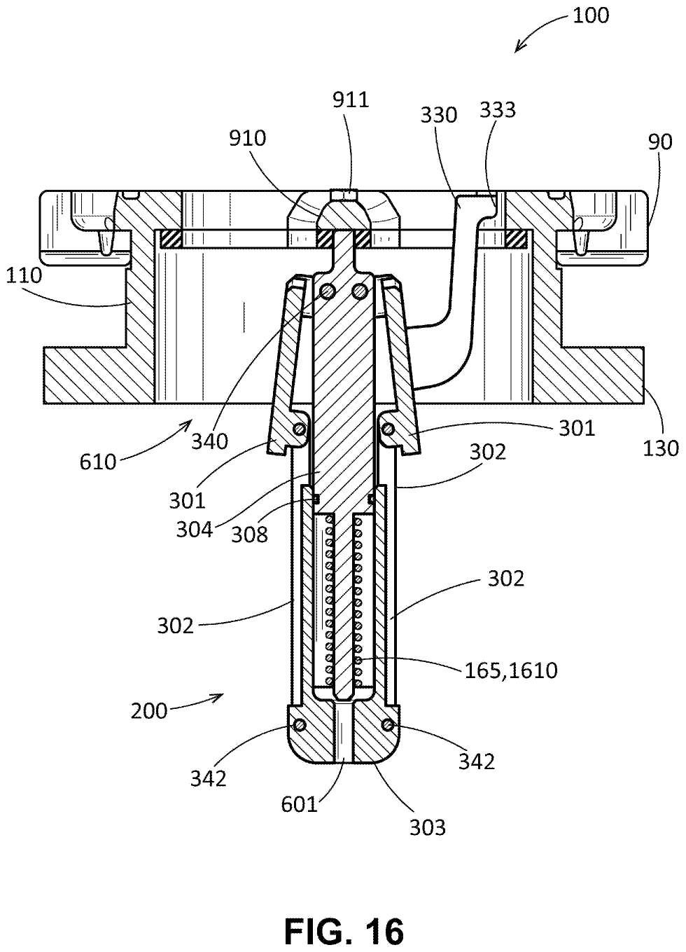

FIG. 16 is a sectional view of the break check valve 100 shown in the open position. As shown, the break check valve 100 or the one or more valve members 301 thereof can be biased. More specifically, the break check valve 100 or the one or more valve members 301 thereof can be biased towards a particular position. In some aspects, the break check valve 100 can comprise a biasing element 1610, which can be received within or about or otherwise coupled to the cylinder 303 or, more generally, a surrounding portion of the valve closure device 200. More specifically, the break check valve 100 can comprise a spring biasing element such as, for example and without limitation, a compression spring 165. In some aspects, the compression spring 165 can maintain a position of each of the valve member 301 in an opened position until flow of the fluid through the fitting 80 causes closure of the break check valve 100. In some aspects, a compression spring 165 such as a spring, can be used to provide a resistive force to the linkages 302. In some aspects, the biasing element 1610 and, more specifically, the compression spring 165, such as, for example and without limitation, a coil spring or a wave spring or any compressible structure defining a spring constant can be disposed in the cylinder 303 and in mechanical communication with the cylinder 303 and the piston 304. In some aspects, the spring constant of the biasing element 1610 can be constant. In some aspects, the spring constant can be variable. More specifically, the spring constant can vary based on the displacement of the biasing element 1610 or the amount of compression or tension in the biasing element 1610. In some aspects, the compression spring 165 can be configured with sufficient spring tension to engage with and retard the motion of the cylinder 303 relative to the piston 304 during a closing event. In an exemplary aspect, the spring bias elements can be torsion springs and can be fixed in relative position within the cylinder 303 or, again, otherwise coupled to the cylinder 303. In some aspects, the compression spring 165 can be structured to encircle the piston 304 and be retained in place thereby.

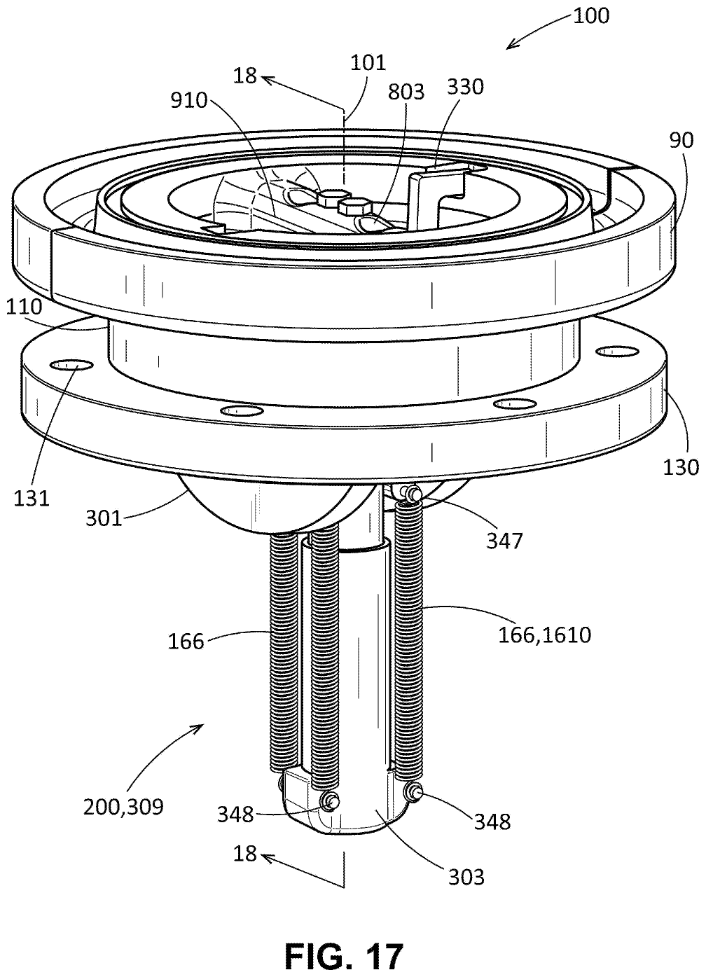

FIG. 17 is a perspective view of the break check valve 100 in accordance with another aspect of the current disclosure and shown in the open position. In some aspects, the linkages 302 can be or comprise one or more of the biasing elements 1610, which can be or comprise tension springs 166. In some aspects, the break check valve 100 can comprise a plurality of tension springs 166, which can be configured to apply a tension force to the valve member 301. In some aspects, the tension springs 166 can be configured to work in unison with the hydraulic dampener 309 assembly. In some aspects, the tension springs 166 can be in mechanical communication with the valve member 301 via a first tension pivot 347. In some aspects, the biasing elements can be in mechanical communication with the cylinder 303 via a second tension pivot 348.

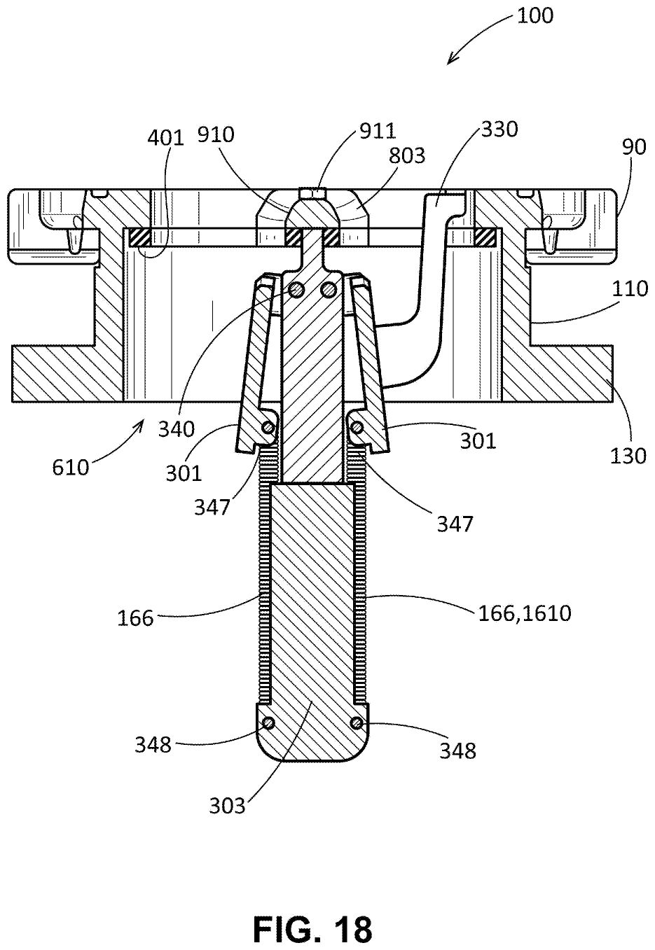

FIG. 18 is a sectional view of the break check valve 100 of FIG. 17 in accordance with another aspect of the current disclosure and shown in an open position. In some aspects, the break check valve 100 can comprise a plurality of tension springs 166 which can be in mechanically coupled to the cylinder 303 and valve member 301. In some aspects, the closure rate of the valve member 301 during a closure event can be controlled by the spring rate and/or spring length of the tension springs 166. In some aspects, the tension springs 166 can be configured to provide a spring force to the valve member 301. In certain aspects, the spring force can be operable to retain the valve member 301 in an open position prior to a dislocation event.

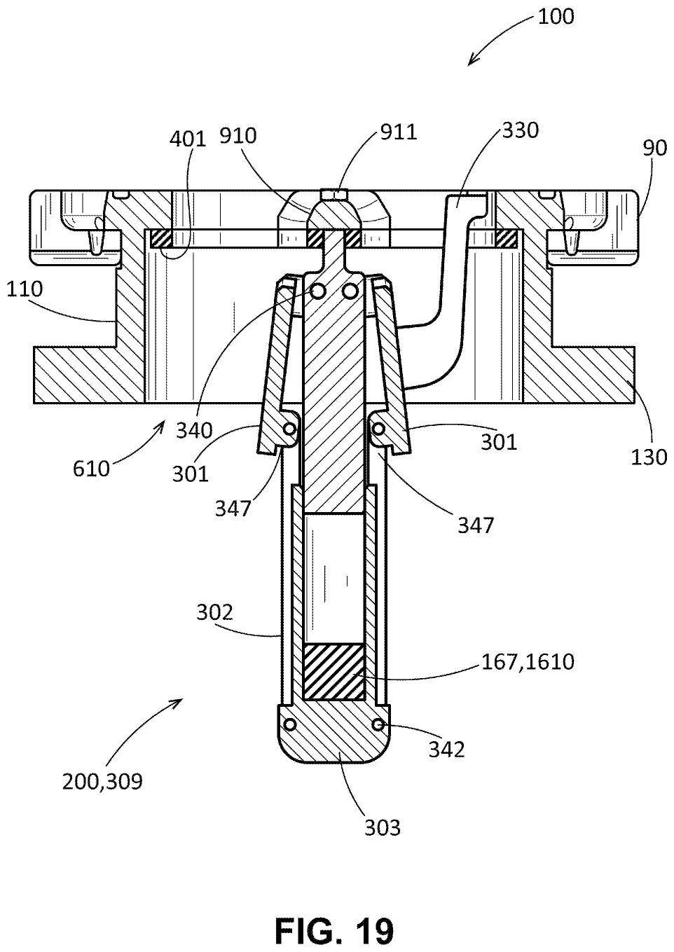

FIG. 19 is a sectional view of the break check valve 100 of FIG. 15 shown in the open position in accordance with another aspects of the present disclosure. In some aspects, the biasing element 1610 can comprise a compressible element or, more specifically, a compression block 167. The compression block 167 can be configured to deform when a force is applied. In certain aspects, the compression block 167 can be configured to absorb a force similar to a crumple zone in an automobile. The compression block 167 can be constructed from a malleable material, such as, for example and without limitation, polyurethane, a soft metal, wood, or the like. 100. During a dislocation event, the piston 304 can be urged by the linkages 302 to translate axially and downwardly in the cylinder 303 and engage the compression block 167. During engagement, the compression block 167 can be configured to deform and retard the motion of the piston 304. In some aspects, the compression block 167 can be configured to control the motion of the valve member 301 during a dislocation event. In some aspects, the compression block 167 can be composed of a substantially elastomeric material such as, for example and without limitation, a rubber or polymeric material. The elastic material can occupy a first shape, can deform under load into a second shape, and can return to the first shape after the load is removed. As shown, the hydraulic dampener 309 need not comprise the seal 308, and thereby some fluid, even a small amount of flow, can be allowed to flow through a gap between the piston 304 and the cylinder 303 during movement of the cylinder 303 with respect to the piston 304 and, more generally, during operation of the hydraulic dampener 309. Closure of the hydraulic dampener 309 can thereby be regulated by such fluid movement or by deformation of the biasing element 1610 or both.

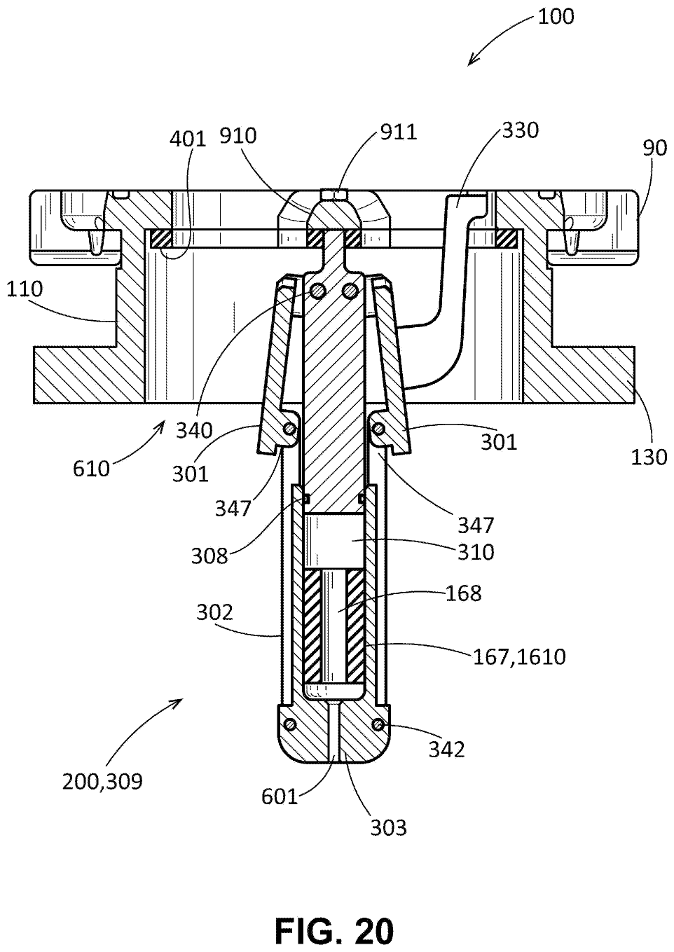

FIG. 20 is a sectional view of the break check valve 100 in accordance with another aspect of the current disclosure and shown in the closed position. In some aspects, as shown, the biasing element 1610 and, more specifically, the compression block 167 can define a bore or cavity 168. The cavity 168 can allow for adjustment of the deformation of the compression block 167 upon closure of the break check valve 100. In some aspects, the compression block 167 can deform at a first spring rate and then later deform at a second spring rate after a change in shape, e.g., compression, of the compression block 167. The second spring rate can be slower or lower than the first spring rate. Definition of the passage 601 can facilitate some flow of the fluid from the cylinder cavity 310, which can further adjust the rate of closure of the break check valve 100.

A method of using the break check valve 100 can comprise initiating closure of the break check valve 100 upon dislocation of the fitting 80 from the break check valve 100 by rotation of each of the valve member 301 as a result of pressure of the fluid of the fitting 80 against each of the valve member 301. The method can comprise resisting rotation or dampening closure of each of the valve member 301 of the break check valve 100 during closure of the break check valve 100 with the piston 304 and cylinder 303, together forming a hydraulic dampener 309. In some aspects, more specifically, the method can comprise slowing or dampening the valve member 301 before contacting the valve body 110 with the valve member 301. In some aspects, more specifically, resisting rotation or dampening closure of each of the valve member 301 of the break check valve 100 during closure of the break check valve 100 with the hydraulic dampener 309 can comprise sliding the cylinder 303 of the hydraulic dampener 309 with respect to the piston 304.

In some aspects, sliding the cylinder 303 of the hydraulic dampener 309 with respect to the piston 304 can comprise pushing out of the hydraulic dampener 309, typically under pressure, the fluid held within the cylinder cavity 310 of the cylinder 303. In some aspects, sliding the cylinder 303 of the hydraulic dampener 309 with respect to the piston 304 can comprise pushing, typically under pressure, the dampening fluid held within the cylinder cavity 310 of the hydraulic dampener 309 from a first portion of the cylinder cavity 310 to a second portion of the cylinder cavity 310.

A method for using the pipe system fitting 80 or any portion thereof can comprise providing the fitting 80 or any portion thereof as disclosed herein. The method can comprise maintaining an open position of the valve member 301 as long as the fluid of the fitting 80 flows in the positive flow direction of the break check valve 100, wherein a positive direction can be defined as in an upward direction or towards the fitting 80. The method can further comprise automatically rotating the valve member 301 of the break check valve 100 from the open position to the closed position of the break check valve 100 when the fluid of the fitting 80 flows in the negative flow direction, wherein the negative flow direction can be defined at inwardly toward the system, of the break check valve 100. The method can further comprise the valve members 301 during closure changing their respective positions or orientations with respect to the valve body 110 of the break check valve 100. As also shown, the method can comprise the valve member 301 in the closed position of the break check valve 100 substantially stopping or completing stopping flow of the fluid from the system. By “substantially stopping flow,” including as shown with respect to exemplary aspects disclosed herein, it is meant that all flow is stopped except for any incidental flow from the valve due to minor gaps between the parts when the valve is closed, any purposeful backflow of the fluid, or purposeful venting or streaming of water as described below-such as through the holes defined in the cross member 910 for example, to alert passersby of a problem with the fitting 80. In some aspects, leakage due to gaps and any purposeful venting of water as described can measure less than 5% of total flow.

The method can comprise expelling a limited stream of water from the break check valve 100 through holes such as the one or more signal holes 803 defined in the valve body 110 when the break check valve 100 is in the closed position to indicate closure of the break check valve 100 and a resulting need for attention and service by appropriate service personnel. In some aspects, the method can comprise expelling a stream of water from the break check valve 100 and through the cross member 910 or the valve member 301 of the break check valve 100. For example, the stream of water could be a focused jet extending high enough into the air (a minimum of five feet, in some aspects, to reach above a top of a parked vehicle) for one to notice it. In some aspects, the method can comprise expelling the stream of water from the break check valve 100 and through a gap defined between the cross member 910 or the valve member 301 and the valve body 110 of the break check valve 100. By expelling water from the break check valve 100 when the break check valve 100 is closed, the break check valve 100 can, as noted above, effectively and clearly indicate to passersby that something may be amiss with the fitting 80 and specifically that the fitting 80 may be dislocated from its usual position, giving them and any nearby public safety personnel the ability to notify responsible parties that the fitting 80 requires attention.

In some aspects, rotating the valve member 301 of the break check valve 100 can comprise rotating a pair of valve members 301 about the pivot 340 of the break check valve 100 from the open position to the closed position. In some aspects, rotating the valve member 301 of the break check valve 100 can comprise expelling a hold-open bar (not shown) from the break check valve 100 and thereby allowing rotation of the valve member 301 within the valve body 110 from the open position to the closed position. Furthermore, rotating the valve member 301 of the break check valve 100 can comprise slowing the speed of the valve member 301 proximate to the closed position with structures positioned between the valve body 110 and the valve closure device 200 and, more specifically, the valve member 301. In some aspects, for example, slowing the speed of the valve closure device 200 can comprise contacting the valve member 301 mechanically coupled to the biasing element 1610 such as, for example only and without limitation, the compression spring 165 or the tension spring 166 r a fluid-filled piston such as the hydraulic dampener 309.

The method can comprise installing the fitting 80 at any angular position about the axis 101 with respect to an angular position of the break check valve 100 without affecting the ability of the break check valve 100 to remain closed when the fitting 80 is coupled to the break check valve 100 and open when the fitting 80 is separated from the break check valve 100. This rotation of the fitting 80 to a desirable angular position based on the availability of multiple angular positions is called “clocking” of the fitting 80. The method can comprise re-using the break check valve 100 as-is after actuation of the break check valve 100 and after replacing the fitting 80 (even a new fitting 80, as needed) to the break check valve 100. The method can comprise resetting an existing break check valve 100 or a replacement break check valve 100 without disassembly any portion thereof such as, for example, the valve closure device 200 or, more specifically, the hydraulic dampener 309. The method can comprise, for example, resetting the break check valve 100 in 30 seconds or less. In various aspects, one or more of the various ports can, for example, allow air to escape from and/or a fluid of the system to recharge, i.e., re-enter and sufficiently fill, a cavity defined in the hydraulic dampener 309. The method can comprise replacing one or more fittings such as, for example and without limitation, the pipe system fitting 80 or the fittings 305,306 with a new fitting to improve or otherwise change performance of the system.

In some aspects, the break check valve 100 and various components thereof can be formed from or comprise an iron (including cast iron and ductile iron), bronze, or steel material including stainless steel or even a plastic (e.g., polymeric) or composite material, which can be reinforced with fibers. In some aspects, any suitable materials can be used. In some aspects, the break check valve 100 and various components thereof can be formed using casting and/or machining processes. In some aspects, any suitable processes can be used. In some aspects, various components of the break check valve 100 can be formed from or comprise a metal such as, for example and without limitation, steel or cast iron. In some aspects, the various components can be formed from any other material, any of which can optionally be corrosion-resistant or replaceable for serviceability. The various components of the break check valve 100 can be formed from any one or more of a variety of manufacturing processes. Components can be fabricated using subtractive manufacturing processes such as machining, forging, stamping; additive manufacturing processes such as three-dimensional printing; and any other forming and assembly processes such as bending and riveting.

As shown, the break check valve 100 can be easily replaced by a new break check valve 100, or the break check valve 100 can replace an older style valve or be installed where no break check valve is currently installed. The break check valve 100 can also be reset without replacement or modification upon reinstallation of the fitting 80 by returning the components of the break check valve 100 to their respective original positions.

One should note that positional language, such as, among others, “can,” “could,” “might,” or “may,” unless expressly stated otherwise, or otherwise understood within the context as used, is generally intended to convey that certain aspects include, while other aspects do not include, certain features, elements, and/or steps. Thus, such positional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any combinations and sub-combinations of all elements, features, and aspects discussed above. All such modifications and variations are intended to be included within the scope of the present disclosure, and all possible claims to individual aspects or combinations of elements or steps are intended to be supported by the present disclosure.

That which is claimed is:

1. A valve closure device for a break check valve, the valve closure device comprising:
a valve member configured to rotate from an open position to a closed position only when a pipe system fitting initially coupled to the break check valve is separated from the break check valve; and
a hydraulic dampener coupled to the valve member in each of the open position and the closed position of the valve member, the hydraulic dampener configured to resist rotation of the valve member towards the closed position of the valve member;
the hydraulic dampener defining:
a first end configured to be coupled to a valve body of the break check valve; and
a second end distal from the first end with respect to an axis of the valve closure device; and
the hydraulic dampener defining a port configured to restrict flow of fluid from the hydraulic dampener during operation thereof.

2. The valve closure device of claim 1, wherein the hydraulic dampener is able to recharge and reset automatically.

3. The valve closure device of claim 1, wherein the port is one of air bleed port defined in a position between the first end and the second end of the hydraulic dampener, an exit port defined in the second end, and a gas fill port.

4. The valve closure device of claim 2, wherein the port is the air bleed port.

5. The valve closure device of claim 3, wherein the port is an exit port comprising or defining a nozzle, the nozzle being configured to restrict flow of a fluid of the hydraulic dampener from a cavity of the hydraulic dampener.

6. The valve closure device of claim 3, wherein a fitting in received in at least one of the air bleed port and the exit port, the fitting able to be selectively assembled to and removed from a cylinder of the valve closure device, the fitting being able to be replaced with a new fitting rated for either greater or lesser flow than the fitting.

7. The valve closure device of claim 4, wherein the fitting comprises a filter.

8. The valve closure device of claim 1, wherein the port is a first port defined in the second end of the hydraulic dampener, a nozzle received within or defined in the first port, the valve closure device further comprising a second port in the second end, a check valve received within the second end and configured to allow fluid into the hydraulic dampener but not out of the hydraulic dampener.

9. The valve closure device of claim 1, further comprising a position block secured to the valve body and defining a pivot bore, the hydraulic dampener being secured to the position block.

10. The valve closure device of claim 1, wherein the valve member is a first valve member, the valve closure device further comprising a second valve member configured to rotate from an open position of the second valve member to a closed position of the second valve member only when the pipe system fitting initially coupled to the break check valve is separated from the break check valve.

11. The valve closure device of claim 10, wherein the hydraulic dampener is coupled to the second valve member in each of the open position and the closed position of each of the second valve member, the hydraulic dampener configured to resist rotation of the second valve member towards the closed position of the second valve member.

12. The valve closure device of claim 11, wherein the hydraulic dampener further comprises:
a cylinder; and
a piston slidably coupled to and positioned at least partially within the cylinder, one of the piston and the cylinder coupled to the first valve member and the second valve member, an axis of each of the piston and the cylinder being aligned with an axis of the valve bore.

13. The valve closure device of claim 1, wherein the hydraulic dampener further comprises:
a cylinder; and
a piston slidably coupled to and positioned at least partially within the cylinder, one of the piston and the cylinder coupled to the valve member and the second valve member, an axis of each of the piston and the cylinder being aligned with an axis of the valve bore.

14. The valve closure device of claim 1, wherein the hydraulic dampener further comprises:
a first cylinder defining a first cylinder cavity;
a second cylinder defining a second cylinder cavity and coupled to the first cylinder, the second cylinder cavity in fluid communication with the first cylinder cavity;
a first piston slidably coupled to and positioned at least partially within the first cylinder; and
a second piston slidably coupled to and positioned at least partially within the second cylinder;
wherein the hydraulic dampener is coupled to the valve member.

15. A valve closure device for a break check valve, the device comprising:
a valve member configured to rotate from an open position to a closed position only when a pipe system fitting initially coupled to the break check valve is separated from the break check valve;
a cylinder coupled to the valve member; and
a biasing element received within or coupled to the cylinder, the biasing element configured to resist rotation of the valve member towards the closed position of the valve member.

16. The valve closure device of claim 15, further comprising a linkage member coupling the cylinder to the valve member, wherein the biasing element is a compression spring.

17. The valve closure device of claim 16, wherein the compression spring is received within the cylinder.

18. The valve closure device of claim 15, wherein the biasing element is a tension spring coupling the cylinder to the valve member.

19. The valve closure device of claim 18, wherein the biasing element comprises a plurality of tension springs, at least a first tension spring of the plurality of tension springs coupled to the first valve member and at least at least a second tension spring of the plurality of tension springs coupled to the second valve member.

20. The valve closure device of claim 15, wherein the valve member is a first valve member, the valve closure device further comprising a second valve member configured to rotate from an open position of the second valve member to a closed position of the second valve member only when the pipe system fitting initially coupled to the break check valve is separated from the break check valve.

21. The valve closure device of claim 20, wherein the linkage member is a first linkage member, the valve closure device further comprising a second linkage member coupled to the second valve member; the biasing element being configured to resist rotation of the second valve member towards the closed position of the second valve member.

22. The valve closure device of claim 20, wherein the biasing element comprises a plurality of tension springs, at least a first tension spring of the plurality of tension springs coupled to the first valve member and at least at least a second tension spring of the plurality of tension springs coupled to the second valve member.

23. The valve closure device of claim 15, wherein a spring constant of the biasing element varies based on a displacement of the biasing element.

24. A break check valve comprising:
a valve body defining a mating surface at a first axial end, the valve body defining a valve bore, the valve bore extending from a first axial end to a second axial end;
a valve member positioned within the valve body and configured to rotate from an open position to a closed position; and
a dampener coupled to each of the valve body and the valve member, and the second valve member, the dampener configured to resist rotation of the valve member during closure of the break check valve;
the dampener defining:
a first end configured to be coupled to a valve body of the break check valve;
a second end distal from the first end with respect to an axis of the break check valve and coupled to the valve body only through the first end; and
the dampener comprising one of a hydraulic dampener and a biasing element.

25. The break check valve of claim 24, wherein the break check valve comprises a first arm and a second arm, the first arm extending from the first valve member but not past a mating surface of the valve body when the first valve member is in the open position, and the second arm extending from the second valve member but not past the mating surface of the valve body when the second valve member is in the open position.

26. The break check valve of claim 24, wherein the dampener comprises the hydraulic dampener, the hydraulic dampener defining an exit port proximate to the second end and a nozzle received within the exit port.

27. A method of using the break check valve of claim 24, the method comprising:
keeping the break check valve open as long as a pipe system fitting coupled to the break check valve remains coupled to the break check valve;
initiating closure of the break check valve upon dislocation of the pipe system fitting from the break check valve by rotation of each of the first valve member and the second valve member as a result of fluid pressure against each of the first valve member and the second valve member; and
dampening closure of each of the first valve member and the second valve member of the break check valve during closure of the break check valve with the dampener.

28. The method of claim 27, further comprising resetting the break check valve automatically upon movement of each of the first valve member and the second valve member to the respective open positions and without disassembly of the break check valve.

29. The valve closure device of claim 24, wherein the valve member is a first valve member, the valve closure device further comprising a second valve member configured to rotate from an open position of the second valve member to a closed position of the second valve member only when the pipe system fitting initially coupled to the break check valve is separated from the break check valve.

30. The valve closure device of claim 29, wherein the dampener is coupled to the second valve member, the dampener configured to resist rotation of the second valve member during closure of the break check valve.
